(19) United States
(12) Patent Application Publication
(10) Pub. No.: US 2014/0297353 A1
(43) Pub. Date: Oct. 2, 2014

(54) METHOD AND SYSTEM FOR CREATING AND DISTRIBUTING FINANCIAL APPLICATION WORKFLOWS

(71) Applicants: Amarendra Srivastava, Bangalore (IN); Saurabh Saxena, Bangalore (IN)

(72) Inventors: Amarendra Srivastava, Bangalore (IN); Saurabh Saxena, Bangalore (IN)

(21) Appl. No.: 13/853,903

(22) Filed: Mar. 29, 2013

(51) Int. Cl. G06Q 10/06

(52) U.S. Cl. CPC G06Q 10/06316
USPC 705/7.26

(57) ABSTRACT

A method for creating and distributing a workflow for performing a task in a financial application involves receiving an instruction from a workflow creator to begin recording the workflow, where the workflow comprises a chronological ordering of steps which include the task; at the behest of the workflow creator, a step within the workflow is generated; an action performed within the financial application is detected, where the action is an atomic portion of the task, and added to the step; input from the workflow creator to the financial application is detected and a prompt is added to the step; after the cessation of recording, a preview of the workflow is displayed to the workflow creator for approval; if the user approves, a workflow file including the workflow is created and uploaded to a server, which notifies financial applications that the workflow for performing the task is available on the server.

### BACKGROUND

Financial management software for small businesses can be a powerful tool. With such software, users can perform numerous accounting tasks required for or helpful to the small business. To perform accounting task, users are required to follow certain workflows. Many users struggle to find the right workflow to accomplish their tasks. Users are not currently able to easily share workflows with each other, especially those workflows that are created for their specific business needs.

### SUMMARY

In general, in one aspect, the invention relates to a method for creating and distributing a workflow for performing a task in a financial application. The method includes receiving an instruction from a workflow creator to begin recording the workflow, where the workflow includes a chronological ordering of steps which include the task, generating, at the behest of the workflow creator, a step within the workflow, detecting an action being performed within the financial application, where the action is an atomic portion of the task, adding the action to the step. detecting input from the workflow creator to the financial application, adding, in response to detecting the input, a prompt to the step, where the prompt is an instruction to a workflow user to provide an analogous input to the financial application, displaying, after the cessation of recording, a preview of the workflow to the workflow creator for approval, creating, in response to the approval, a workflow file including the workflow, uploading the workflow file to a server, and notifying, by the server, financial applications that the workflow for performing the task is available on the server.

In general, in one aspect, the invention relates to a financial application, executing on a computer processor. The financial application includes: a user interface by which a workflow creator performs a task within the financial application; a listener module executing on the computer processor and including functionality to monitor interactions between the workflow creator and the user interface, detect that an action has been performed by the workflow creator within the financial application, and detect input from the workflow creator to the financial application; a recording module executing on the computer processor and including functionality to receive an instruction from the workflow creator to begin recording the workflow, where the workflow includes a chronological ordering of steps which include the task, generate, in response to the instruction, a step within the workflow, add, in response to detecting the action, the action to the step in response to the listener module indicating that the action has been performed, add, in response to detecting the input, a prompt to the step, where the prompt is instruction to a future user to provide an analogous input to the financial application, display, after the cessation of recording, a preview of the workflow to the user for approval, create, in response to the approval, a workflow file including the workflow, upload the workflow file to a server, and notify, by the server, financial applications that the workflow for performing the task is available on the server.

In general, in one aspect, the invention relates to a non-transitory computer readable medium including instructions to receive an instruction from a workflow creator to begin recording the workflow for the task, where the workflow includes a chronological ordering of steps which include the task, generate, at the behest of the user, a step within the workflow, detect an action being performed within the financial application, where the action is an atomic portion of the task, add the action to the step, detect input from the workflow creator to the financial application, add, in response to detecting the input, a prompt to the step, where the prompt is an instruction to a workflow user to provide an analogous input to the financial application, display, after the cessation of recording, a preview of the workflow to the workflow creator for approval, create, in response to approval, a workflow file including the workflow, upload the workflow file to a server, and notify, by the server, financial applications that the workflow for performing the task is available on the server.

Other aspects of the invention will be apparent from the following description and the appended claims.

### BRIEF DESCRIPTION OF DRAWINGS

FIG. 1 shows a system for recording, distributing and playing back workflows in accordance with one embodiment of the invention.

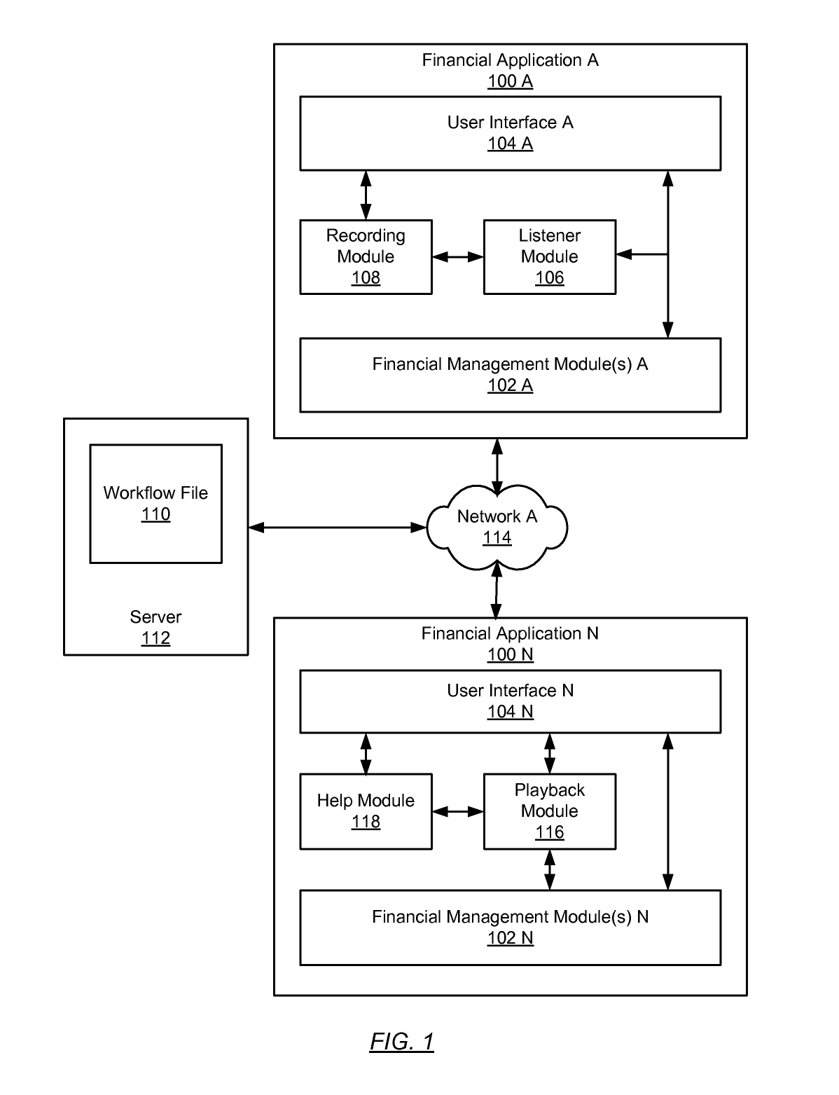

FIG. 2 shows a workflow in accordance with one embodiment of the invention.

FIG. 3 shows a method for creating a workflow in accordance with one embodiment of the invention.

FIG. 4 shows a method for playing back a workflow in accordance with one embodiment of the invention.

FIG. 5A shows an example of a workflow being recorded in accordance with one or more embodiments of the invention.

FIG. 5B shows an example of a workflow being played back in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, the use of “FIG.” in the drawings is equivalent to the use of the term “Figure” in the description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention, relate to a method and system for creating and distributing a workflow for performing a task within a financial application. A user creating a workflow (the workflow creator) instructs the financial application to begin recording a workflow. The workflow is created by recording actions performed by the user and the financial application, as well as determining when and what input should be entered, and adding prompts for users of the workflow to do so. The actions and prompts are sorted into steps, which are groups that accomplish specific sub-tasks of the primary task. After the workflow has been completed and approved by the workflow creator, it is uploaded to a server, and multiple additional financial applications are made aware of the existence of a new workflow for performing the task. When users (workflow users) of the additional financial applications require assistance in performing the task, their financial applications may automatically download the appropriate workflow from the server, and play it back to aid the workflow users in completing the task.

In one embodiment of the invention, a financial application (100A, 100N) includes functionality to perform tasks related to financial management. The finances managed may include those of individuals, small businesses, and larger companies. In one embodiment of the invention, a financial application (100A) includes functionality to create a workflow to perform one of the aforementioned tasks. A second financial application (100N) may include functionality to play back the workflow recorded by the first financial application (100A) in order to perform the task. In one embodiment of the invention, both of the financial applications (100A, 100B) may include functionality to both create and play back workflows.

In one embodiment of the invention, the financial applications (100A, 100N) include one or more financial management modules (102A, 102N). A financial management module (102A, 102N) may include functionality to perform a wide variety of financial management tasks, including bookkeeping, accounting, tax preparation, investment management, personal banking, etc. In one embodiment of the invention, a single financial management module (102A, 102N) may only include functionality to perform a specific subset of the possible tasks. Alternately, a single financial management module (102A, 102N) may include functionality to perform a wide variety of tasks. In one embodiment of the invention, one financial management module (102A, 102N) may include, or have access to additional modules, which include functionality to perform more specialized subsets of tasks.

For example, a financial application (100A, 100N) which includes functionality to manage personal finances may include a personal banking module and a tax preparation module. The personal banking module might include functionality to monitor the accounts of a user, in addition to tracking debts, bill payments, sources of income, and other data items related to personal finance. The tax preparation module might include functionality to obtain data items related to preparing taxes, and automatically obtain relevant tax forms and/or fill out information on those forms. The tax preparation module may further include functionality to obtain certain data items from the personal banking module. This may be done automatically, or at the behest of the user. In one embodiment of the invention, the tax preparation module may require that the personal banking module generate a statement or determine an account balance in order to obtain required information. In this case, the tax preparation module may instigate an appropriate action within the personal banking module.

In one embodiment of the invention, the financial application (100A, 100N) includes a user interface (UI) (104A, 104N). The UI (104A, 104N) may be an event-driven graphical user interface which includes functionality to generate events when input or a user action is detected. The generated events are observed by the modules to which the actions are directed, and appropriate action is taken in response. The events may also be observed by other components and modules of the financial application (100A, 100N) which observe the framework of the UI (104A, 104N). Further, modules (102A, 102N) of the financial application (100A, 100N) may include functionality to generate events and create objects within the UI (104A, 104N) in order to communicate information to the user. As with user-driven events, events and object generated by the modules (102A, 102N) may also be observed by other entities with access to the UI (104A, 100N) framework.

For example, if a user selects a button object within the UI (104A, 104N) would generate an event corresponding to that button object. An event handler within the framework of the UI (104A, 104N) would observe that the button object has been selected and notify an appropriate module, which would then perform an action associated with the button object. If, for example, the action was to open a new window, then the module would create a new object within the UI (104A, 104N) framework, and generate a corresponding event. All of these events would be detectable and reproducible by a module with access to the UI (104A, 104N) framework

In one embodiment of the invention, the financial application includes a listener module (106) with functionality to observe actions performed by the workflow creator and the financial management modules (102A, 102N) within the UI (104A, 104N) framework. The listener module (106) may simply pass notifications of all detected events to a recording module (108). In one embodiment of the invention, the listener module (106) only includes functionality to recognize and report a predefined set of events generated within the UI (104A, 104N). Alternately, or additionally, the listener module (106) may include functionality to interpret and analyze events and only notify the recording module (108) of events relevant to certain actions being performed. The listener module (106) may also include functionality to collect additional data associated with an event. This data may include, for example, the identity of the data structure or module that produced and consumed the event, any subsequent events triggered as a result of the event, the creation or destruction of elements in the UI (104A, 104N), or any other general results of the event. In one embodiment of the invention, the listener module (106) may include functionality to observe actions performed by the financial management modules (102A, 102N) independent of the UI (104A, 100N). For example, if one financial management module (102A, 102N) invokes a second financial management module (102A, 102N) to perform a specific task, the listener module (106) may be include functionality to observe this interaction. Alternately, or additionally, the listener module (106) may include functionality to determine the changes to the state of a module, document or other data structure with the financial application (100A, 100N) as a result of a series of actions.

In one embodiment of the invention, the financial application (100) includes a recording module (108). The recording module (108) may receive information on actions performed by the workflow creator and the financial management modules (102A, 102N) from the listener module (106). The information received may be a simple notification of an event. Alternately, a specific action associated with the event may be added to the workflow. The specific action may be determined by the listener module (106). In one embodiment of the invention, the listener module (106) adds an instruction to perform a specific action corresponding with the event.

In one embodiment of the invention, the workflow is composed entirely of recorded events; in this case, when the listener module (106) detects that an event has occurred, the recording module (108) adds that event verbatim to the workflow being recorded. When the workflow is later played back by a workflow user, the playback module (116) generates that event, spoofing the original user input to the UI (104A, 104N) to perform the task. In one embodiment of the invention, the recording module (108) only adds an event or action to the workflow if a change in the state of the UI (104A, 104N) or one of the modules (102A, 102N) of the financial application (100A, 100N) is detected. For example, if a financial management module (102A, 102N) displays a pop-up menu after a first action is performed, the first action may not be recorded. However, if a flag corresponding to some feature of the financial management module is altered as a result of a subsequent action performed within the menu, the subsequent action, or result of the action, will be added to the workflow. The recording module (108) may be restricted to only record certain actions, or may only be able to record actions occurring within certain modules of financial application (100A, 100N). In one embodiment of the invention, the workflow creator is able to set options of the recording module (108) which specify restrictions on what the recording module (108) is able or required to record.

The recording module (108) may include functionality to group multiple actions into steps within the workflow. A step may include a series of actions that accomplish a specific task that is part of the larger task of the workflow. The steps may be determined automatically by the recording module (108) based on a similarity of a series of actions. Alternately, certain detected events or actions may indicate the beginning or end of a step. For example, the detection of an event signaling the creation of a window in the UI (104A, 104N) of the financial application (100A, 100N), followed by a series of events corresponding to actions being performed within that window, and finally an event corresponding to the destruction of the window, would likely indicate that the actions performed were part of a discrete task, and the recording module (108) might group them as such within the workflow.

In one embodiment of the invention, the workflow creator is able to access and control the recording module (108) directly. The recording module (108) may include functionality for the workflow creator to group detected actions into steps or add rules and restrictions to what input a workflow user of the workflow can enter. The rules and restrictions may also dictate that certain actions or groups of actions must be performed and how the actions should be performed. In one embodiment of the invention, the workflow creator adds notes or instructions to the workflow. An instruction may describe input or actions required from a user to complete the task; a note may explain the purpose or result of a step or action within the workflow, or disclose other information related to how the workflow is used or the task to which the workflow is directed. The recording module (108) may also allow workflow creator to enable or disable the recording module (108) during the workflow recording session.

In one embodiment of the invention, the workflow is stored as a workflow file (110). The workflow may be stored in the workflow file (110) using extensible mark-up language (XML) format. The workflow file (110) may generated by the recording module (108). The contents of the workflow file (110) may be instructions which are accessed and directly executed by the financial management modules (102A, 102N). Alternately, the contents of workflow file (110) may be accessed by a playback module (116) which interprets the contents of the workflow file (110) and performs actions or issues instructions based on the interpretation. The playback module (116) is discussed below.

In one embodiment of the invention, the workflow file (110) is automatically uploaded to a server (112). The server (112) may be accessible to any instance of the financial application (100A, 100N) over a network (114). In one embodiment of the invention, the financial application (100A, 100N) includes a module (not shown) that includes functionality to connect to the server (112) and upload workflow files (110), as well as view and download workflow files (110) that are already on the server (112). This functionality may be divided between the recording module (108) and the playback module (116). Alternately, or additionally, the workflow creator may be able to directly upload workflow files (11) to the server (112), as well as browse and download workflow files (110) already on the server (112). The server (112) may connect to many different financial applications (112) operated on different machines by different users. In one embodiment of the invention, users access the server (112) via a website or other mechanism which displays the contents of the server (112). The server (112) may include functionality to notify and update financial applications (100A, 100N) whenever a new workflow file (110) has been uploaded.

In one embodiment of the invention, the financial application (100A, 100N) is connected to a network (114). The network may be, for example, the Internet, a wide area network (WAN), or a local area network (LAN)), with wired and/or wireless segments, or any other mechanism by which two or more computers may be connected. In one embodiment of the invention, the financial application (100A, 100N) includes a specific module (not shown) with functionality to connect to the network (114). The financial application (100A, 100N) may connect to the network (114) to access the server (112), communicate with other financial applications (100A, 100N), or access other online resources.

In one embodiment of the invention, the financial application (100A, 100N) includes a playback module (116). The playback module (116) may include functionality to access a workflow file (110). The workflow file (110) may be obtained from the server (112) directly by the playback module (116). In one embodiment of the invention, the playback module (116) includes functionality to display the contents of the workflow contained within the workflow file (110) in a portion of the user interface (104) of the financial application (100). In one embodiment of the invention, the format that the playback module (116) uses to display the workflow is obtained from the workflow file (110). Alternately, the workflow user may select a preferred format. In one embodiment of the invention, the playback module (116) displays the workflow as a series of selectable links corresponding to steps in the workflow. Upon the selection of a link, any notes associated with the step may be displayed to the workflow user, the actions of the step may be performed automatically by the playback module (116), and the workflow user may be prompted to enter any input required to complete the step. In one embodiment of the invention, only the link associated with the current step is selectable, and the next step becomes selectable after the current step has been completed. Depending on actions performed during a step, different steps may become selectable after the completion of the step.

In one embodiment of the invention, the financial application (100A, 100N) includes a help module (118). The help module (118) may include functionality to assist users in troubleshooting the financial application (100A, 100N), and provide instructions or assistance to a user performing tasks using the financial application (100A, 100N). In one embodiment of the invention, the help module (118) includes an index of the workflows available on the server (112). Additionally, the help module (118) may include functionality to search the server (112) for a specific workflow; to download and import the workflow file (110) of the workflow; and to play back the workflow using the playback module (116). In one embodiment of the invention, the help module (118) presents the option to access a workflow when a user seeks help regarding a specific task. The help module (118) may further include functionality to receive updates from the server (112) whenever a new workflow file (110) is updated.

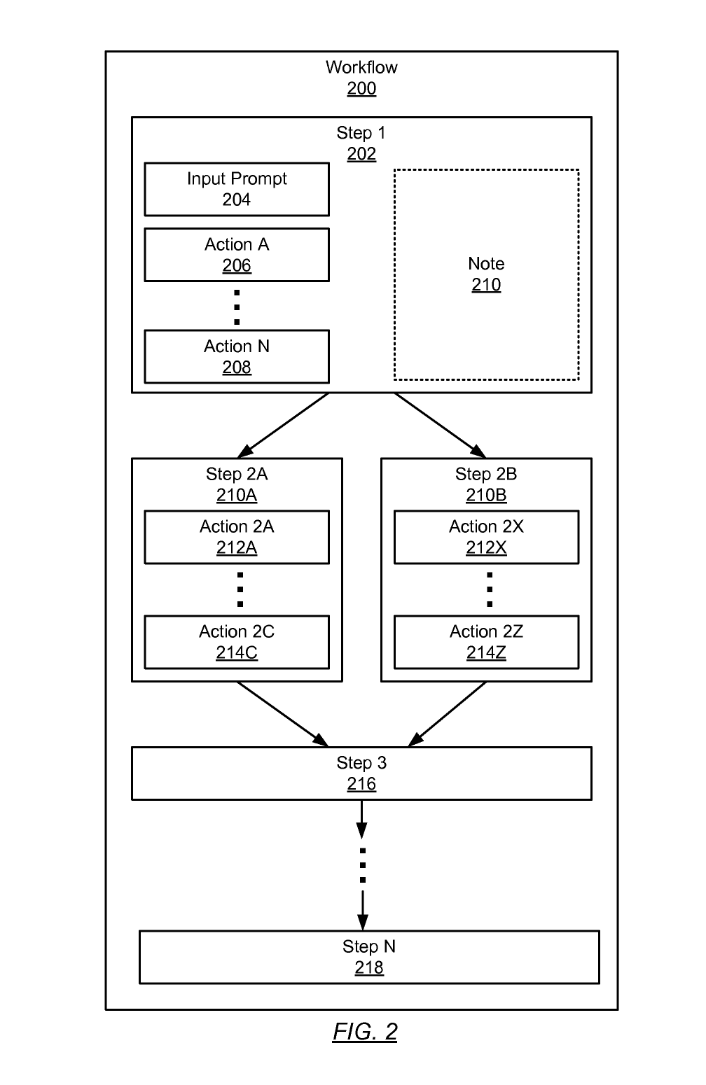

FIG. 2 shows a workflow (200) in accordance with one embodiment of the invention. FIG. 2 is not meant to represent an actual data structure, but rather a conceptual example of the arrangement of the various components of a workflow. The steps (e.g., step 1 (202), step 2A (210A), step 2B (210B), step 3 (216), step N (218)), prompts (e.g., input prompt (204)), actions (e.g., action A (206), action N (208), action 2A (212A), action 2C (214C), action 2X (212X), action 2Z (214Z)), and notes (e.g., note (210)) that make up a workflow (200) may be displayed to the workflow user as shown in FIG. 2. Alternately, everything but the steps may be concealed. The various components are described below. The workflow (200) may have components stored in a static data structure. Alternately, the workflow (200) may be generated from a template and data in order to be used. In one embodiment of the invention, the workflow (200) is stored and accessed as an XML file.

In one embodiment of the invention, the workflow (200) is composed of multiple steps. A step is a grouping of actions and prompts, which together accomplish a discrete subset of the task that the workflow (200) seeks to accomplish. In one embodiment of the invention, a step includes a note (210). The note (210) may be a text description or instructions added by the workflow creator. The steps of a workflow (200) may be stored and performed in a fixed sequence corresponding to the order in they were recorded. Alternately, steps which do not have a direct dependency upon previous steps may be performed in any order. In one embodiment of the invention, the workflow (200) provides the workflow user with an option to walk the workflow user through performing a given step to teach the workflow user to perform the task without depending the workflow (200). Alternately, a step may be performed automatically aside from portions for which the workflow user is required to provide some input.

In one embodiment of the invention, a single step (e.g. (step 1 (202)) results in multiple possible outcomes. The different outcomes may result in different progressions of steps (e.g., step 2A (210A), step 2B (210B)) being followed in the workflow. The different progressions of steps may include different progressions of actions (e.g., action 2A (212A)-action 2C (212C), action 2X (212X)-action 2Z (214Z), as well as different input prompts. The different progressions of steps (e.g., step 2A (210A), step 2B (210B)) may share steps, or may completely distinct; the different progressions of steps (e.g., step 2A (210A), step 2B (210B)) may eventually converge into a single progression of steps (e.g., step 3 (216)-step N (218)).

In one embodiment of the invention, a step (e.g., step 1 (202)) in the workflow (200) may include one or more input prompts (e.g., input prompt (204)). An input prompt (204) is an instruction to the workflow user to enter input required by the financial application to perform the task. The input may include data or text to be entered by the workflow user, and may include specification of target files or data, selection of options, and approval or verification of actions that involve sensitive information or external consequences. The input prompt (204) may present the workflow user with a custom request for input, which may include a description or explanation of the input needed. The description or explanation may be added by the workflow creator. In one embodiment of the invention, the input prompt (204) may simply perform an action (e.g., action A (206)-action N (208)) which causes the user interface or appropriate financial management module to present the workflow user with a request for input as it would if the workflow user were performing the task manually. In one embodiment of the invention, the input the workflow user is allowed to enter may be restricted by rules. The rules may be inherent to the required input, or they may be added by the workflow creator.

In one embodiment of the invention, a step (e.g. step 1 (202)) in the workflow (200) includes one or more actions (e.g., action A (206)-action N (208)). Actions (e.g., action A (206)-action N (208)) correspond to atomic events performed in either the user interface or the financial management modules of the financial application. In one embodiment of the invention, the action (e.g., action A (206)-action N (208)) is stored in the workflow (200) as an event that when replayed in the user interface will effectuate the action (e.g., action A (206)-action N (208)) by the either the user interface or the appropriate financial management module. Alternatively, the action (e.g., action A (206)-action N (208)) may be an instruction to the playback module by which the workflow (200) is being accessed. The instruction may be to send an instruction the appropriate component of the financial application to perform the action (e.g., action A (206)-action N (208)) or may specify that the action may be performed directly by the playback module.

In one embodiment of the invention, a step (e.g. step 1 (202)) in the workflow (200), includes one or more notes (e.g., note (210)) added by the workflow creator. A note (210) may be text added to the workflow (200) which describes a specific step, prompt, or action. A workflow user may be required to view the note (210) in order for the workflow (200) completed or viewing the note (210) may be optional.

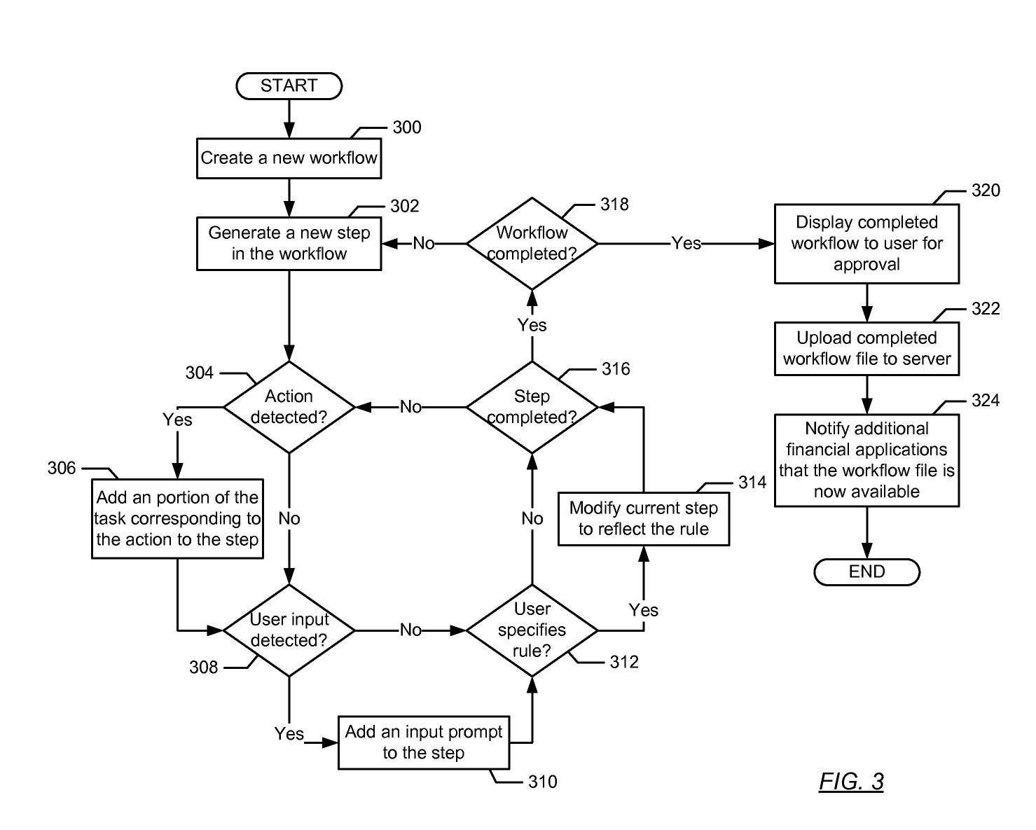

FIG. 3 shows a flowchart for creating a workflow in accordance with one embodiment of the invention. While the various steps in the flowchart are presented and described sequentially, one of ordinary skill will appreciate that some or all of the steps may be executed in different orders, may be combined or omitted, and some or all of the steps may be executed in parallel.

In Step 300, a new workflow is created in accordance with one or more embodiments of the invention. A new workflow file may be created as soon as recording of the workflow is started, and may be labeled and categorized based on the task it is meant to perform. The workflow file may be created, accessed, recorded and altered as an XML file. Alternately, the workflow may be entirely recorded and then an XML file for the workflow is generated after it is complete. In one embodiment of the invention, instead of a new workflow being created, an existing workflow is opened, and any actions performed are added to the existing workflow, or replace portions of it. In this case the workflow creator may specify a point in the workflow at which to begin recording.

In Step 302, a new step in the workflow is generated in accordance with one or more embodiments of the invention. The creation of a new step may be specified by the workflow creator. Creating a new step may automatically mark the end of the previous step. Alternately, the recording module may include functionality to determine that a discrete portion of the task which could be categorized as a step has been finished. In one embodiment of the invention, steps are nested, and one or more sub-steps may be required to perform a larger step. For example, a step may be associated with performing actions specific to a certain window or menu of the financial application. However, in order to finish the task within that window or menu, a second window or menu may need to be opened before every action within the first window has been completed. A second step associated with that window might then be a sub-step of the step associated with the first window. In one embodiment of the invention, a step is labeled by the workflow creator to reflect the portion of the task that is accomplished by its performance. The workflow creator may also add comments or notes explaining the step, and any actions that the end user may be required to perform.

In Step 304, a determination is made as to whether an action has been detected in accordance with one or more embodiments of the invention. The action may have been performed by a financial management module of the financial application, by the user interface of the financial application, or by the workflow creator using either of the above. In one embodiment of the invention, actions are detected by observing events generated within the user interface. Alternately, an action may be detected by observing a change in the state of one of the aforementioned components of the financial application.

If an action is detected in Step 304, in Step 306 an instruction corresponding to that action is added to the current step of the workflow in accordance with one or more embodiments of the invention. The instruction added to the step may be a copy of the event, which will cause the action to occur if it is replayed within the scope of a user interface of a financial application. Alternately, it may be an instruction which is issued within the financial application to perform the action directly.

In Step 308, a determination is made as to whether user input has been detected in accordance with one or more embodiments of the invention. In one embodiment of the invention, user input includes entering text, selecting options, uploading files, and other actions that require the workflow user to provide information that cannot be automatically selected. In one embodiment of the invention, the workflow creator indicates that user input is required in the workflow. Alternately, the recording module may include functionality to detect that text has been entered or that a selection has been made.

If input is detected in Step 308, in Step 310 an instruction is added to the workflow to prompt a workflow user to provide corresponding input. In one embodiment of the invention, the prompt highlights the area or object which the workflow user is required to manipulate. Alternately, or additionally, text may be obtained, from either the workflow creator, or another source associated with the input in question which describes the purpose and required parameters of the input that is to be entered.

In Step 312, a determination is made as to whether the workflow creator has specified a rule to be applied to the current step of the workflow in accordance with one or more embodiments of the invention. The workflow creator may add a rule to the workflow by directly accessing the recording module. The rule may include the addition or removal of actions to prevent the workflow user from performing certain actions. Alternately, the rule may restrict what input is allowed, or which options may be selected. For example, a step may require the workflow user to select between three options. If the two of the options allow the task of the workflow to be completed, but a third prevents it, the workflow creator may add a restriction which prevents the workflow user from selecting the third option.

In Step 314, the current step of the workflow is modified to reflect the rule in accordance with one or more embodiments of the invention. The workflow may be directly modified by the workflow creator to reflect the rule. Alternately, the workflow creator may select the rule from a list of predefined rule types, and the step or action to which the rule is being applied is modified in a manner dictated by the rule. In keeping with the previous example, a rule type may exist for restricting options available to a workflow user. The option-restricting rule type is then applied to the instruction associated with option in the example to restrict the choices of the workflow user. In one embodiment of the invention, actions or instructions not present in the financial application are added in order to facilitate the addition of rules and restrictions to the workflow.

In Step 316, a determination is made as to whether the current step has been completed in accordance with one or more embodiments of the invention. As discussed above in the description of Step 302, this determination may be made automatically. In one embodiment of the invention, a step is determined to be complete in response to the detection of certain events. For example, a step may be determined to have been completed by the closure of a window in which a series of actions of the step are performed. The delimiters of a step may also be determined based on observed trends in what actions are being performed, or the processes by which they are being performed. In one embodiment of the invention, distinct steps are not determined until after the workflow is completed. The workflow creator may also adjust the boundaries of automatically set steps as required. As previously mentioned, the workflow creator may also dictate directly when steps begin and end.

In Step 318, a determination is made as to whether the workflow has been completed in accordance with one or more embodiments of the invention. Like other steps, this may be automatically detected based on accomplishment of some goal or the occurrence of some event associated with the task being performed. Alternately, the point at which the workflow has completed may be specified by the workflow creator. In one embodiment of the invention, a notification to the workflow user that the workflow has been completed is added. Alternately, the completion of one workflow may end with an instruction to segue into a second workflow in order to accomplish some larger, more complex task.

In Step 320, if the workflow has been completed, the completed workflow is displayed to the workflow creator for revision and approval in accordance with one or more embodiments of the invention. Displaying the workflow for revision and approval may be identical to how the workflow is played back for the workflow user by the playback module. The workflow creator may be required to complete the entire workflow, and add descriptions or verify that workflow is functional for its intended purpose. In addition to approving the workflow, the workflow creator may also add notes or instructions to the workflow at this point.

In Step 322, after the completed workflow has been approved, the workflow is uploaded to a server in accordance with one or more embodiments of the invention. Once on the server, the workflow may be made available to be downloaded and played back by other instances of the financial application. In one embodiment of the invention, this is performed automatically by the recording module after receiving approval from the workflow creator. In one embodiment of the invention, the financial application of the workflow creator has permission to access the server in order to upload a workflow. In one embodiment of the invention, the workflow needs to be reviewed and approved by a third party or moderator of the server before it is made available for download on the server.

In Step 324, financial applications that are connected to the server are informed that a new workflow is available in accordance with one or more embodiments of the invention. The financial applications may include help modules which automatically index the available workflows and make them available to users seeking help in performing tasks. The server or the help modules may identify a category or type of the task which the workflow performs, and may make the workflow available if that category within the help module is accessed. In one embodiment of the invention, the workflow itself is distributed to the financial applications, either immediately after it is uploaded, or as part of a patch or update distributed periodically by the server.

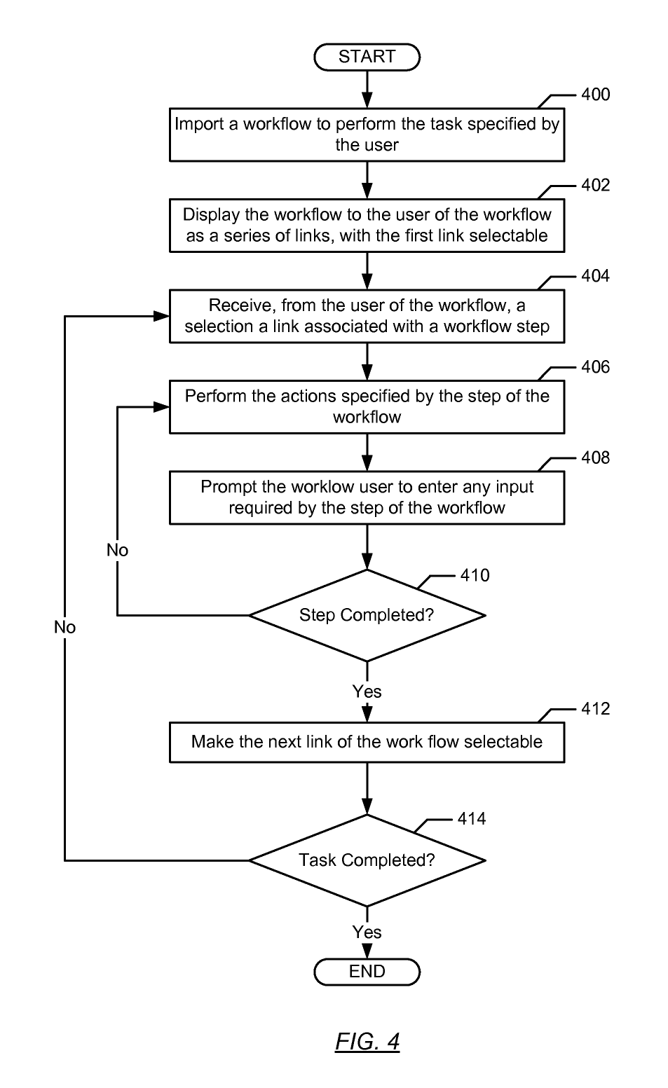

FIG. 4 shows a flowchart for utilizing an extant flowchart in accordance with one embodiment of the invention. While the various steps in the flowchart are presented and described sequentially, one of ordinary skill will appreciate that some or all of the steps may be executed in different orders, may be combined or omitted, and some or all of the steps may be executed in parallel.

In Step 400, a workflow is imported by a financial application of a workflow user in accordance with one embodiment of the invention. The workflow user may obtain the workflow to be imported by accessing the server storing uploaded workflows directly. The server may be accessible to the workflow user through a website. After the workflow has been downloaded the workflow user may instruct the financial application to import the workflow. Alternately, the financial application may include functionality to automatically detect new workflows.

In one embodiment of the invention, the financial application includes functionality to access the server and display the workflows that have been uploaded. The financial application may download and import the workflow automatically in response to a request for help from the workflow user. The financial application may select the workflow based on the categorization of the workflow on the server, as well as ratings from other workflow users, and other heuristics based on data collected from other financial applications that have been used the workflow in similar situations. The financial application may include functionality to upload details of the utilization of the workflow for use by other financial applications.

In Step 402, the imported workflow is displayed by the financial application to the workflow user in accordance with one or more embodiments of the invention. In one embodiment of the invention, the workflow is displayed as a series of selectable links corresponding to steps. The playback module of the financial application may include functionality to create a new window in which to display the workflow. The workflow may initially display all of the links, with only the first in the workflow selected. After the current step has been completed, the link for the next step in the progression may become available for selection. If some steps are conditional upon the outcome of an earlier step, not all steps may become selectable. Alternately, the workflow may be performed in the background of the financial application autonomously, and the workflow user is only presented with portions where input is required.

In one embodiment of the invention, the actions which make up a step are displayed as well. In the case that actions are displayed, the actions may be displayed as a progression of selectable links the same way that the steps in the workflow are displayed. In one embodiment of the invention, in addition to just actions and input prompts, a step includes one or more sub-steps. The sub-steps may represent sequential portions of the task to be performed, or may represent alternate, or optional, branches of actions that are required to complete the step, which may or may not be taken based on input or selection of options provided by the workflow user.

In Step 404, an instruction to perform a step is received from the workflow user in accordance with one or more embodiments of the invention. As discussed above, this may occur in the form of the workflow user selecting a link associated with the step. Alternately, the workflow user may be prompted to initiate the next step upon the completion of the previous step. In one embodiment of the invention, the process is entirely automated and aside from entering required input, nothing is required of the workflow user, including the selection of steps.

In one embodiment of the invention, any descriptions, comments, instructions, or other information that is appended to the step as a note is displayed to the workflow user. The information in the note may include descriptions of the actions being performed by the step or instructions for potential input the workflow user may have to provide. The note may be displayed adjacent to the selectable link associated with the step, may pop up upon selection of the link, or may only be displayed if requested by the workflow user.

In Step 408, any actions that are part of the step, and which do not require any user input, are performed automatically in accordance with one or more embodiments of the invention. In one embodiment of the invention, an action is stored in the workflow as the user interface event which precipitated the action when the workflow was created. In this case, when the playback module performs the action in question, the original event is performed by the playback module of the workflow user's application which in turn causes the action to be performed. Alternately, the workflow may store instructions to perform actions, and the instructions are issued to the appropriate financial management module by the playback module in order to perform the action. In one embodiment of the invention, an action may be stored as instructions which are interpreted by the playback module. The playback module may then access both the user interface and the financial management module in order to perform the action.

In one embodiment of the invention, the action (or even the entire step) is stored in the workflow as a set of changes to be made to the state of the financial application, or to data stored therein in accordance with one or more embodiments of the invention. For example, if the workflow user is being guided through a task that includes adding personal information stored by the financial application, the workflow user may be prompted with a request to provide the information to be stored, and then change the appropriate file of the financial application, rather than performing all the steps a user might take to add the information manually.

In Step 410, if the completion of the step requires any user input, the workflow user is prompted to enter appropriate input in accordance with one or more embodiments of the invention. Input may include datapaths or uploaded files, entered text, the selection of options, and approval or verification of actions that involve sensitive information or external consequences. In one embodiment of the invention, the workflow user is prompted to enter all required input at the beginning of the step. If later input required by a step is depends upon earlier choices or information gotten from input, the workflow may include rules or instructions that predict or specify what input will be required by the financial application based upon the input that has already been provided. Alternately, the workflow user may be prompted to enter input as it is required by the financial management module(s). In one embodiment of the invention, prompts for input include instructions to the workflow user regarding details of the input that is required. The workflow may also include rules and restrictions that govern what input the workflow user may enter. In one embodiment of the invention, the playback module may provide a custom interface for the workflow user to enter the required input; the input collected with the custom interface may then be passed from the custom interface to the user interface or appropriate financial management module.

In Step 412, a determination is made as to whether the step has been completed in accordance with one or more embodiments of the invention. Determining whether the step has been completed may be a simple matter of reaching the end of the actions in the step. In one embodiment of the invention, the step is determined to have been completed if certain conditions are met. If the step has not been completed, Steps 408 and 410 may be repeated until it the step has been completed. In one embodiment of the invention, other steps that do not depend on a step may be performed prior to the completion of the step.

In Step 414, after the previous step has been completed a link associated with the next step in the workflow is made selectable in accordance with one or more embodiments of the invention. In one embodiment of the invention, if the progression of steps in the workflow is branched based on the outcome of a prior step, a link associated with the first step of that branch will become selectable, and an alternate branch is removed. In one embodiment of the invention, a link associated with a step is not shown at all until the prior step has been completed. Links for all steps that have been completed may be displayed and may be selectable while the workflow is in progress. In one embodiment of the invention, the workflow user may select a link associated with a previous step to return the progress of the workflow to that point in the task. Doing so may require the workflow user to reenter any input in steps after the one selected. The links associated with the subsequent steps may also become unselectable if the progress reverts to a previous step. Alternately, if the workflow user alters any input provided to the previous step, the changed input will be propagated down the progression of completed steps that follow the changed step.

In Step 416 a determination is made as to whether the task has been completed in accordance with one or more embodiments of the invention. This may simply be determined by the end of the workflow being reached. Alternately, this may be indicated by the workflow user, if the task has been completed to their satisfaction. In one embodiment of the invention, the workflow user is prompted to review any information collected, changes made to the program, or end products in order to verify that the task has been completed. The workflow user may also be prompted to rate the workflow to determine the helpfulness and efficacy for future use in obtaining and providing appropriate workflows for tasks.

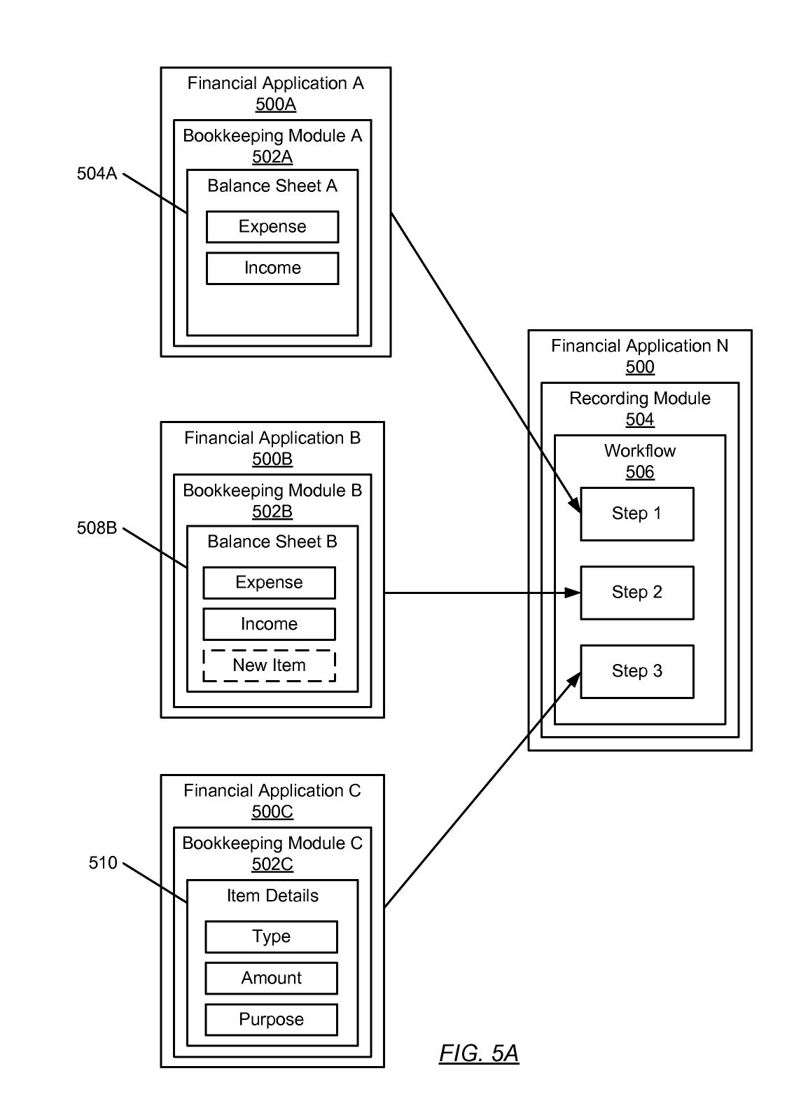

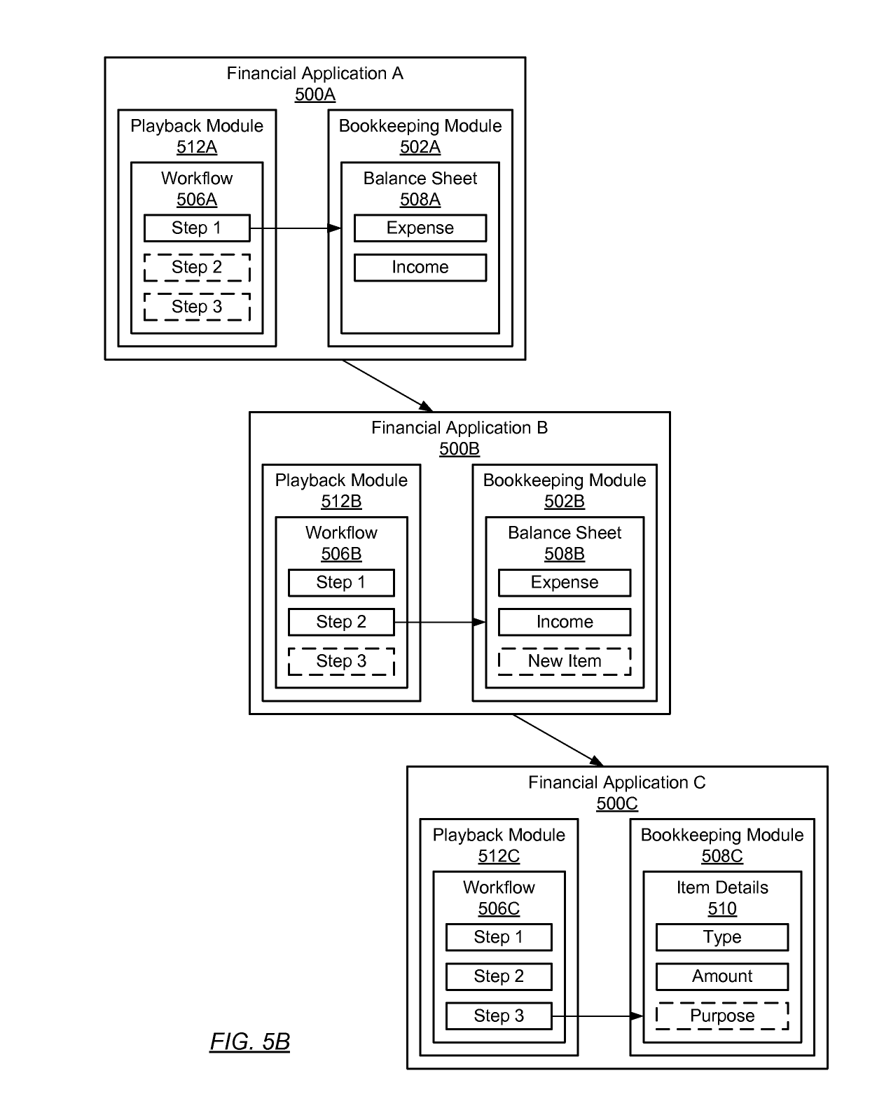

FIGS. 5A and 5B show an example in accordance with one embodiment of the invention. The following example is for explanatory purposes only and not intended to limit the scope of the invention.

In FIG. 5A a workflow (506) for performing a simple task within the financial application (500A, 500B, 500C), namely adding an expense to an balance sheet (508), is created by a workflow creator and uploaded to a server, and in FIG. 5B the workflow (506) is downloaded by a workflow user, and used to aid the workflow user in adding the balance sheet (508) to the workflow (506).

In FIG. 5A, the workflow creator decides to create a workflow (506) to assist in adding an expense to a balance sheet (508) being maintained by the financial application (500A, 500B, 500C). The workflow creator opens the financial application (500A, 500B, 500C), and instructs the financial application (500A, 500B, 500C) to create a new workflow (506). The workflow creator then goes to a point in the financial application (500A, 500B, 500C) from which to begin recording the workflow (506), and instructs the recording module (504) of the financial application (500) to begin recording. The recording module (504) creates a new workflow (506) file, and adds a new step.

In this example, the first action that the workflow creator takes is to open the select the appropriate balance sheet (508A, 508B) to add the expense to. This accomplished by selecting the balance sheet (508) from a list of data items currently being maintained by a bookkeeping module (502A, 502B, 502C) of the financial application (500A, 500B, 500C). The recording module (504) detects the selection, and adds a prompt to the workflow (506) for a workflow user to select an item to modify. The workflow creator may also opt to add a rule which specifies that only data items identified as balance sheets (508A, 508B) may be selected. The recording module (504) detects that a window which displays the balance sheet (508A, 508B) is opened, and creates a new step in the workflow (506) corresponding to actions occurring within that window.

After the balance sheet (508A, 508B) has been added, the workflow creator opens a drop-down menu with balance sheet (508A, 508B) editing options, and selects an ‘add item’ button in the menu, which creates a new item in the balance sheet (508A, 508B). The resulting action of the bookkeeping module (502) adding the item is added to the workflow (506), but the individual steps of opening the menu and selecting the ‘add item’ option are omitted.

After the new item has been added to the balance sheet (508A, 508B) the workflow creator may right-click the new item and select an option to edit the item. Selecting the option to edit brings up a new window for editing the data of the item. As previously, only an action corresponding to the creation of the window is added to the workflow (506). The recording module (504) also creates a new step associated with the editing specific window. The recording module (504) detects the fields of the window into which the workflow creator enters input, and adds prompts to the current step which instruct the workflow user to provide analogous input. As with the selection of the balance sheet (508A, 508B), the workflow recorder may pause the recording, and add rules to the input prompts which restrict the information and selections provided by a workflow user. In this example, the workflow user may have free reign to enter to edit details like amount and purpose, but may be precluded from selecting options such as “this expense is repeating”, unless it is specifically part of the workflow (506).

The workflow creator then selects a ‘Save item’ or ‘Apply’ button, which prompts the edits to the item to be made permanent and may cause the window to close The recording module (504) adds a corresponding action. If the window closes, the recording module (504) marks the current step as complete.

Finally, the workflow creator specifies that the workflow (506) has been completed. The recording module (504) then walks the workflow creator through the workflow (506), allowing the workflow creator to append notes and instructions to the steps to be displayed to a workflow user when the workflow (506) is utilized. The workflow creator may also add, remove, or rearrange any actions or prompts, and set the beginning/end of steps if necessary. After the workflow creator has approved the workflow (506), the workflow creator may add labels and a name to the workflow (506). The workflow (506) may then be saved as an XML file. Finally, the workflow creator may select an option of the recording module (504) of the financial application (500A, 500B, 500C), which uploads the completed workflow (506) to a server. The workflow creator may also obtain a copy of the workflow (506) to distribute by other means, if necessary.

After the workflow (508A, 508B) has been uploaded to the server, the server distributes a notification to other financial applications (500A, 500B, 500C) connected to it, that a new workflow (506) for adding an item to a balance sheet has been added. The financial applications (500A, 500B, 500C) make the new workflow (506) accessible to users by selection of a link within their help menus.

In FIG. 5B a workflow user requires assistance in adding an expense to a balance sheet (508A, 508B, 508C) using a financial application (500A, 500B, 500C). The workflow user opens the application, and accesses the help menu (not shown). In response to a request for help adding an item to a balance sheet (508A, 508B, 508C), the help menu provides a link to the workflow (506A, 506B, 506C) on the server that was created in the previous example. Upon selection of the link in the help menu, the workflow (506A, 506B, 506C) file is automatically downloaded by the financial application (500A, 500B, 500C) and is imported by playback module (508A, 508B, 508C). The playback module (508A, 508B, 508C) reads the file and opens a window displaying the workflow (506A, 506B, 506C) as a series of selectable links corresponding to the three steps of the workflow (506A, 506B, 506C). Initially, only the first link is selectable.

The workflow user selects the first step, which opens the bookkeeping module (502) and prompts the workflow user to input information specifying the balance sheet (508A, 508B, 508C) they wish to modify. The workflow user specifies the balance sheet (508A, 508B, 508C), and the next link becomes selectable. The workflow user selects the link corresponding to adding a new item to the balance sheet (508A, 508B, 508C), which adds a new item to the balance sheet (508A, 508B, 508C), and the final link becomes selectable. The workflow user selects this link, which opens the window by which the details of the item are edited, and prompts the workflow user to provide input required to complete the task of the workflow (506A, 506B, 506C). When the playback module (508A, 508B, 508C) has determined that appropriate input has been obtained, the balance sheet (508A, 508B, 508C) is saved and the workflow user is alerted that the task has been completed.

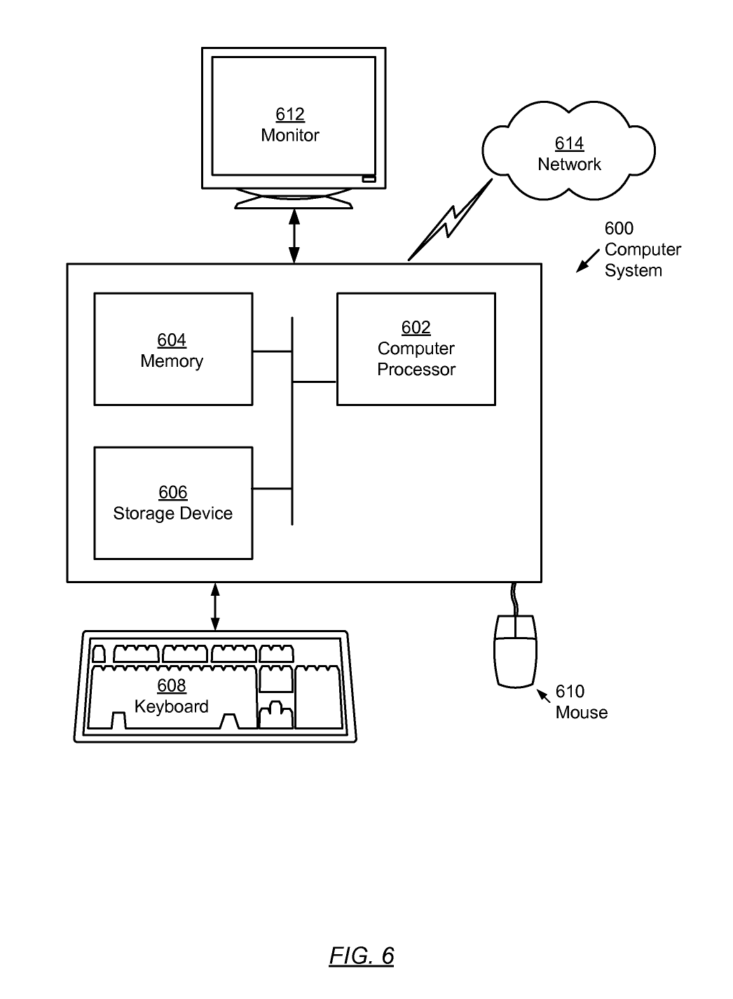

Embodiments of the invention may be implemented on virtually any type of computer regardless of the platform being used. For example, as shown in FIG. 6, a computer system (600) includes one or more computer processor(s) (602) (e.g., hardware processor, integrated circuit, central processing unit, etc.), associated memory (604) (e.g., random access memory (RAM), cache memory, flash memory, etc.), a storage device (606) (e.g., a hard disk, an optical drive such as a compact disk drive or digital video disk (DVD) drive, a flash memory stick, etc.), and numerous other elements and functionalities typical of today's computers (not shown). The computer (600) may also include input means, such as a keyboard (608), a mouse (610), or a microphone (not shown). Further, the computer (600) may include output means, such as a monitor (612) (e.g., a liquid crystal display (LCD), a plasma display, or cathode ray tube (CRT) monitor). The computer system (600) may be connected to a network (614) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, those skilled in the art will appreciate that one or more elements of the aforementioned computer system (600) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions to perform embodiments of the invention may be stored, temporarily or permanently, in whole or in part, on a non-transitory computer readable medium such as a compact disc (CD), a local or remote storage device, local or remote memory, a diskette, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for creating and distributing a workflow for performing a task in a financial application, comprising:
receiving an instruction from a workflow creator to begin recording the workflow, wherein the workflow comprises a chronological ordering of steps which comprise the task;
generating, at the behest of the workflow creator, a step within the workflow;
detecting an action being performed within the financial application, wherein the action is an atomic portion of the task;
adding the action to the step;
detecting input from the workflow creator to the financial application;
adding, in response to detecting the input, a prompt to the step, wherein the prompt is an instruction to a workflow user to provide an analogous input to the financial application;
displaying, after the cessation of recording, a preview of the workflow to the workflow creator for approval;
creating, in response to the approval, a workflow file comprising the workflow;
uploading the workflow file to a server; and
notifying, by the server, a plurality of financial applications that the workflow for performing the task is available on the server.

2. The method of claim 1, further comprising:
amending the step to reflect a rule specified by the user, wherein the rule specifies parameters for the analogous input.

3. The method of claim 1, further comprising:
detecting, after the detection of the first action, a second action being performed within the financial application; and
adding the second action to the step.

4. The method of claim 3, further comprising:
generating, after the detection of the second action, a second step;
detecting, after the generation of the second step, a third action; and
adding the third action to the second step.

5. The method of claim 1, further comprising:
receiving, from the workflow creator, a note, wherein the note comprises a description of the step; and
appending the description to the step within the workflow.

6. The method of claim 1, further comprising:
receiving, from the workflow creator, a correction of the step within the workflow, wherein the correction comprises a replacement of the action with an alternate action.

7. The method of claim 1, further comprising
importing the workflow file, wherein the workflow file is selected by the workflow user;
extracting, from the workflow file, the workflow;
displaying, within a window of the financial application, the workflow as a plurality of links, wherein one or more of the plurality of links is associated with the step of the workflow;
executing, upon selection of the link by the workflow user, the step, wherein executing the step comprises performing an action within the financial application and prompting the future user to provide the analogous input to the financial application.

8. The method of claim 7, wherein the plurality of links comprises a dependent link associated with a second step, wherein the second step depends upon an outcome of the step, and wherein the dependent link cannot be selected until the previous step has been completed.

9. The method of claim 7, further comprising:
receiving, by the financial application, a notification that the workflow for performing the task is available on the server;
adding, by the financial application, the workflow to an index of workflows; and
displaying an option to access the workflow to the workflow user, when the workflow user seeks help performing the task.

10. The method of claim 7, further comprising:
displaying, adjacent to the step within the window, a note comprising a description of the step.

11. A financial application, executing on a computer processor, and comprising:
a user interface by which a workflow creator performs a task within the financial application;
a listener module executing on the computer processor and configured to:
monitor interactions between the workflow creator and the user interface;
detect that an action has been performed by the workflow creator within the financial application; and
detect input from the workflow creator to the financial application;
a recording module executing on the computer processor and configured to:
receive an instruction from the workflow creator to begin recording the workflow, wherein the workflow comprises a chronological ordering of steps which comprise the task;
generate, in response to the instruction, a step within the workflow;
add, in response to detecting the action, the action to the step in response to the listener module indicating that the action has been performed;
add, in response to detecting the input, a prompt to the step, wherein the prompt is instruction to a future user to provide an analogous input to the financial application;
display, after the cessation of recording, a preview of the workflow to the user for approval;
create, in response to the approval, a workflow file comprising the workflow;
upload the workflow file to a server; and
notify, by the server, a plurality of financial applications that the workflow for performing the task is available on the server.

12. The financial application of claim 11, further comprising:
a playback module executing on the computer processor and configured to:
import the file, wherein the file is selected by a workflow user;
extract, from the file, the workflow;
display, within a window of the financial application, the workflow as a plurality of links, wherein a link is associated with the step of the workflow;
execute, upon selection of the link, the step wherein executing the step comprises performing the action within the financial application and prompting the workflow user to provide the analogous input to the financial application.

13. The financial application of claim 12,
wherein the plurality of links comprises a dependent link,
wherein the dependent link corresponds to a step that depends upon the outcome of a previous step, and
wherein the dependent link cannot be selected until the previous step has been completed.

14. The financial application of claim 11, wherein the recording module is further configured to:
amend the step to reflect a rule specified by the workflow creator, wherein the rule specifies parameters for the analogous input.

15. The financial application of claim 11,
wherein the recording module is further configured to:
receive, from the workflow creator, a correction of the step within the workflow, wherein the correction comprises a replacement of the action with an alternate action.

16. The financial application of claim 12,
wherein the recording module is further configured to:
receive, from the workflow creator, a note, wherein the note comprises a description of the step; and
append the note to the step within the workflow; and
wherein the playback module is further configured to:
display the note adjacent to the link.

17. The financial application of claim 12, further comprising:
a help module executing on the computer processor and configured to:
receive, by the financial application, a notification that the workflow for performing the task is available on the server;
add, by the financial application, the workflow to an index of workflows; and
display an option to access the workflow to the workflow user, when the workflow user seeks help performing the task.

18. A non-transitory computer readable medium comprising instructions to:
receive an instruction from a workflow creator to begin recording the workflow for the task, wherein the workflow comprises a chronological ordering of steps which comprise the task;
generate, at the behest of the user, a step within the workflow;
detect an action being performed within the financial application, wherein the action is an atomic portion of the task;
add the action to the step;
detect input from the workflow creator to the financial application;
add, in response to detecting the input, a prompt to the step, wherein the prompt is an instruction to a workflow user to provide an analogous input to the financial application;
display, after the cessation of recording, a preview of the workflow to the workflow creator for approval;
create, in response to approval, a workflow file comprising the workflow;
upload the workflow file to a server; and
notify, by the server, a plurality of financial applications that the workflow for performing the task is available on the server.

19. The non-transitory computer readable medium of claim 18, further comprising instructions to:
import the workflow file, wherein the workflow file is selected by the workflow user;
extract, from the workflow file, the workflow;
display, within a window of the financial application, the workflow as a plurality of links, wherein a link is associated with the step of the workflow;
execute, upon selection of the link, the step wherein executing the step comprises performing the action within the financial application and prompting the user to provide the analogous input to the financial application.

20. The non-transitory computer readable medium of claim 19, further comprising instructions to:
receive, by the financial application, a notification that the workflow for performing the task is available on the server;
add, by the financial application, the workflow to an index of workflows; and
display an option to access the workflow to the workflow user, when the workflow user seeks help performing the task.
